(19) United States
(12) Patent Application Publication
(10) Pub. No.: US 2005/0092447 A1
(43) Pub. Date: May 5, 2005

(54) Sectional overhead garage door having the simulated appearance of a carriage house door

(76) Inventor: Loren D. Mock, Baldwin City, KS (US)

Correspondence Address: WOMBLE CARLYLE SANDRIDGE & RICE PLLC, 300 N. GREENE STREET, SUITE 1900, GREENSBORO, NC, 27401, US

(21) Appl. No.: 10/699,749

(22) Filed: Nov. 3, 2003

(51) Int. Cl. E05D 15/16

(52) U.S. Cl. 160/201

(57) ABSTRACT

A sectional overhead garage door is disclosed that substantially has the appearance of a traditional carriage house door. Thin-walled sections of the garage door are embossed with relief patterns that provide the door with the desired simulated appearance. The relief patterns may include aligned vertical grooves in the door sections that provide the appearance of a vertical separation between left and right portions of the garage door. A method of producing metal sectional overhead garage doors that simulate the appearance of carriage house doors is also disclosed. The method includes embossing relief patterns in sheet metal door sections using a maximum of three different dies to produce substantial portions of a wide variety of metal sectional overhead garage doors that simulate the appearance of carriage house doors.

### FIELD OF THE INVENTION

The invention relates to garage doors, and more particularly, relates to sectional overhead garage doors.

### BACKGROUND

Sectional overhead garage doors provide a convenient and durable closure for large entrance openings such as garage entryways. Sectional overhead garage doors often include a plurality of horizontally oriented door sections pivotally connected together to form an articulated closure. The door sections typically include sets of rollers that are supported between fixed rails or tracks that guide the movement of the door between a vertically oriented closed position to an overhead, substantially horizontal open position. The sections pivot relative to each other as the sections travel between the open and closed positions. Automatic garage door openers often move the doors between the open and closed positions.

Modern sectional overhead garage doors for residential garages often are constructed of sheet metal, such as steel, aluminum, or the like. These metal doors have substantially replaced wooden sectional doors that are much heavier and more prone to deterioration due to weather, decay and insects. Metal garage doors typically last for many years after installation without substantial maintenance or replacement.

Sectional overhead garage doors are commercially available in sizes that correspond to common sizes of entryways found in residential garages. Doors for typical single-car garages are about eight feet wide, and doors for typical two-car garages are about sixteen feet wide. Such doors are available in both seven foot and eight-foot heights for entryways having corresponding heights. Because most sectional overhead garage doors include four sections, each section of a typical seven-foot four-section door is about 21 inches tall, and each section of a typical eight-foot four-section door is about 24 inches tall.

The sheet metal surfaces of metal overhead garage door sections often include embossed simulated wood grain patterns. The sections typically include embossed relief patterns such that the doors have the simulated appearance of wooden doors comprising a framework of horizontal and vertical frame members and a plurality of panels supported between the frame members. Often, the embossed panels have the appearance of a “raised panel.” The term “raised panel” refers to panel designs that, in relief, have a raised center portion above a surrounding peripheral portion of the panel. Such panel designs resemble wooden doors that have a frame and panel construction. These embossed panel patterns typically are horizontally oriented, i.e. the embossed panels are wider than they are tall.

Door sections may include backings or inserts that provide thermal insulation. For example, such metal door sections may include an insulating foam insert or core behind their embossed sheet metal faces. The exposed surfaces of the metal garage door sections typically are primed and painted to protect the metal from corrosion and to provide an attractive appearance. Steel garage doors also may be galvanized to provide additional resistance to corrosion and rust.

While sectional overhead garage doors provide an effective closure for residential garages, some homeowners prefer the appearance of more traditional non-metal doors. For example, some homeowners prefer the appearance of traditional carriage house doors. Authentic carriage house doors may be found in older homes and more expensive modern homes, and are substantially constructed of wood. These doors typically have a frame and inset panel construction, and may include one or more windows. The wooden frames of authentic carriage house doors may include horizontal, vertical, or diagonal frame members. The wooden inset panels of such doors sometimes comprise a plurality of assembled tongue-and-groove planks. Carriage house doors often are rectangular, but may be arched or have other unique shapes. For large garage entryways, carriage house doors typically include a pair of vertically hung doors that cooperate to close the opening. The term “vertically hung” as used herein refers to doors hung in a manner such that the doors remain vertical in both an open and a closed position. Often, authentic wooden carriage house doors are hinged along their outermost lateral edges, or are suspended on rails such that the doors slide apart horizontally to open. Accordingly, such doors often include a vertical separation between the abutting edges of the two doors.

In an attempt to provide garage doors that have the appearance of carriage house doors but have the utility of sectional overhead doors, some garage door manufacturers offer wooden sectional doors with decorative wooden overlays. These wooden overlays typically are configured to simulate the appearance of wooden frame members like those found in authentic carriage house doors. Unfortunately, their wooden construction makes such doors very heavy and susceptible to damage from weathering, decay, and insects. In addition, such doors are relatively expensive to produce and purchase. Others have attempted to simulate the appearance of a carriage house door by affixing wooden or plastic overlays to a metal sectional overhead door. For example, U.S. Pat. No. 6,148,896 discloses a metal overhead garage door having a plurality of extruded polystyrene members affixed to the outer faces of the metal sections. The plastic members are intended to simulate the appearance of structural support or frame members. Unfortunately, such overlays are subject to separation from their metal sections, and add substantial cost to the manufacture of a sectional garage door. Such doors also may have a shoddy appearance.

Accordingly, there is a need for a non-wooden sectional overhead garage door that substantially has the appearance of a traditional wooden carriage house door without the use of separate overlays to achieve the simulated appearance.

### SUMMARY OF THE INVENTION

The invention includes an overhead garage door comprising a plurality of rectangular garage door sections comprising thin-walled face panels. The term “thin-walled”, as used herein, refers to door components or sections having a relatively thin wall thickness compared to the overall height and width of a wall or panel. For example, a garage door according to the invention may be constructed of thin-walled sheet metal or plastic having a thickness that is less than or equal to about 0.125 inch. The garage door sections are pivotally connected together one above the other. Each door section includes a plurality of relief features embossed in its face panel. The embossed relief features in the faces of the door sections combine to provide the garage door with the simulated appearance of at least two separate, cooperating vertically hung doors constructed of conventional non-metal and non-plastic materials when the garage door is in a closed position.

The invention also includes an overhead garage door comprising a substantially rectangular upper section. The upper section substantially is constructed of a thin-walled material, and includes an upper front face panel, an upper edge, a lower edge, and side edges. The upper front face panel includes a first integrally formed substantially vertical groove that substantially extends between the upper and lower edges. The overhead garage door further includes a substantially rectangular lower section. The lower section substantially is constructed of a thin-walled material and includes a lower front face panel, a top edge, a lower edge, and side edges. The lower front face panel includes a second integrally formed substantially vertical groove that substantially extends between the top and bottom edges. The door further includes at least one connector pivotally connecting the bottom edge of the upper section to the top edge of the lower section. The upper and lower front faces are substantially coplanar when the garage door is in a closed position. The first and second substantially vertical grooves are substantially collinear when the garage door is in the closed position, thereby substantially simulating the appearance of a vertical separation between left and right portions of the upper and lower sections.

The invention further includes an overhead garage door having an embossed pattern. The embossed pattern includes an integrally formed panel portion. The panel portion has a substantially planar portion including a plurality of spaced, vertically oriented, parallel grooves. The substantially planar portion thereby substantially simulates the appearance of a composite panel formed by a plurality of assembled vertically arranged tongue-and-groove planks.

The invention also includes an overhead garage door having an embossed pattern that includes an integrally formed panel portion having a rectangular frame portion bordering top, bottom, and side margins of the panel. The embossed pattern further includes a recessed, substantially planar panel portion disposed within the rectangular frame portion. The pattern also includes at least one integrally formed, diagonally oriented, simulated support member disposed within the frame portion of the panel.

The invention additionally includes a method of constructing an overhead garage door. The method includes providing a set of dies for forming a plurality of embossed patterns in a sheet metal garage door section. The set of dies includes a first die configured for forming a first embossed pattern comprising an integrally formed, diagonally-oriented, upwardly sloping simulated support member. A second die is configured for forming a second embossed pattern comprising a raised, integrally formed, diagonally-oriented, downwardly sloping simulated support member. A third die is configured for forming a third embossed pattern that is substantially different from the first and second embossed patterns. The method further includes producing a plurality of embossed metal garage door sections with the set of dies such that each section includes at least one selected embossed pattern. The method also includes selectively arranging and pivotally connecting the plurality of garage door sections together to form at least a substantial portion of an overhead garage door having a desired appearance in a closed position.

### BRIEF DESCRIPTION OF THE DRAWINGS

FIG. 1 is a perspective view of one embodiment of a sectional overhead garage door according to the invention installed in a garage entryway;

FIG. 2 is an elevation view of a portion of a garage door section having an embossed pattern including a panel having tongue-and-groove design;

FIG. 3 is cross section of the garage door of FIG. 2 taken along line 3-3;

FIG. 4 is cross section of the garage door of FIG. 2 taken along line 4-4;

FIG. 5 is an elevation view of a portion of a garage door section having an embossed pattern including a downwardly sloping simulated diagonal frame member;

FIG. 6 is cross section of the garage door of FIG. 5 taken along line 6-6;

FIG. 7 is an elevation view of a portion of a garage door section having an embossed pattern including an upwardly sloping simulated diagonal frame member;

FIG. 8 is cross section of the garage door of FIG. 7 taken along line 8-8;

FIG. 9 is an elevation view of a garage door section according to the invention;

FIG. 10 is a cross section of the garage door section of FIG. 9 taken along line 10-10;

FIG. 11 is an elevation view of a garage door section have a plurality of embossed patterns that combine to form an arched top; and

FIG. 12 includes elevation views of a plurality of garage doors formed by connected garage door sections embossed with various combinations of the embossment patterns of FIGS. 2, 5, 7, and 11.

### DETAILED DESCRIPTION

In the following description, like reference characters designate like or corresponding parts throughout the several views. Also in the following description, it is to be understood that such terms as “forward”, “rearward”, “front”, “rear”, “left”, “right”, “upwardly”, “downwardly”, and the like are words of convenience and are not to be construed as limiting terms.

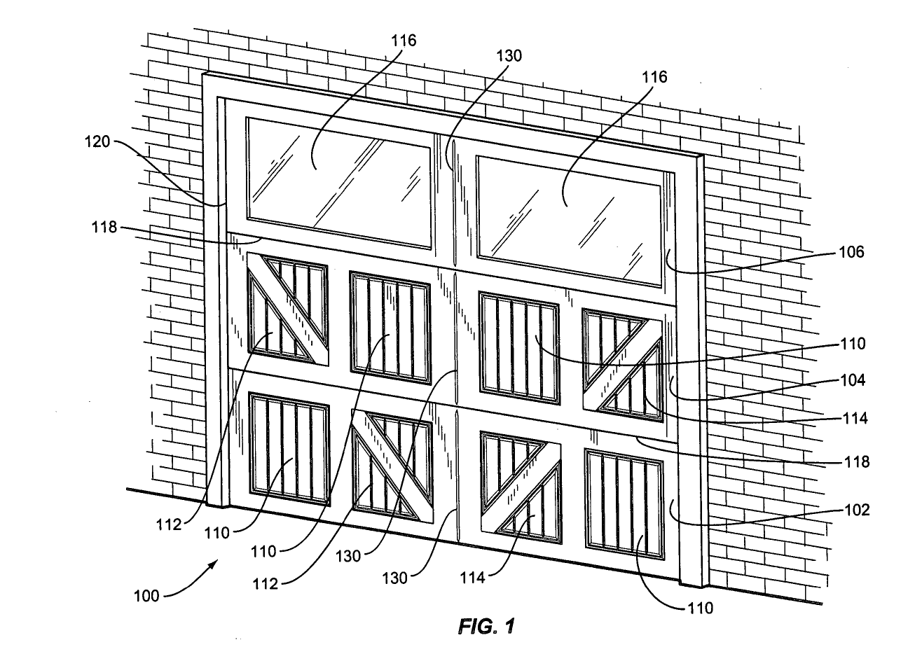

The invention includes a sectional overhead garage door like the embodiment 100 shown in FIG. 1. In FIG. 1, the garage door 100 is in a closed position in a large entryway 120 such as a garage entrance. The garage door 100 includes horizontally oriented sections 102, 104, and 106 pivotally connected to each other along mating horizontal joints 118. The garage door sections 102, 104, 106 each include a vertically aligned groove or crease 130 that substantially align with each other when the garage door 100 is closed. The aligned grooves 130 provide the substantial appearance of a vertically oriented separation between simulated left and right portions of the garage door 100. This apparent separation contributes to the appearance of separate left and right vertically hung doors that abut each other along a line that is coextensive with the grooves 130.

The lower section 102 and middle section 104 of the garage door 100 include one or more embossment patterns 110, 112, and 114. The embossment patterns 110, 112, and 114 are configured and aligned with each other such that the closed door 100 substantially has the appearance of a solid vertically-hung garage door constructed of a plurality of horizontal, vertical, and diagonal frame members, and a plurality of inset panels disposed within the spaces between the frame members. The various surfaces of the garage door sections may be embossed with a textured pattern that resembles a wood grain pattern, for example (not shown).

The upper section 106 of the garage door 100 may include one or more glazed openings 116 as shown. Alternatively, the upper section 106 may be a non-glazed section having one or more embossment patterns that compliment the ornamental appearance of the other door sections 102, 104.

The garage door 100 may have any desired height and width. For example, the door 100 may be about sixteen (16) feet wide and about seven (7) feet tall to fit common two-car garage door entryways. Alternatively, the garage door may be about eight (8) feet tall to fit taller known garage door openings. The garage door 100 operates like known sectional overhead garage doors. As shown in FIG. 1, the door sections 102, 104, 106 are substantially coplanar in a vertical, closed position. The sections 102, 104, 106 are pivotally connected to each other by suitable connectors, and may include rollers that ride in rails or tracks that guide the door 100 to a substantially horizontal overhead position inside a garage when the door 100 is opened (not shown).

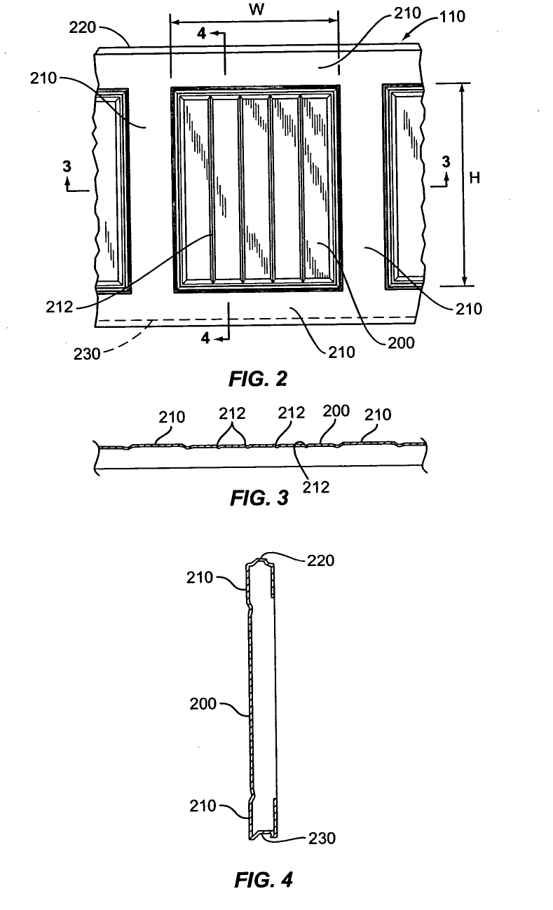

FIGS. 2-4 show one embossment pattern 110 that may be embossed in a door section of a door like that shown in FIG. 1. The pattern includes a recessed panel portion 200 and a raised frame portion 210. The embossment pattern 110 may be formed in the face of a garage door section by stamping or pressing a thin-walled sheet-metal face panel with one or more suitable dies. Alternatively, the pattern 110 may be integrally molded in a thin-walled plastic face panel, for example. The term “thin-walled”, as used herein, refers to door components or sections having a relatively thin wall thickness compared to the overall height and width of a wall or panel. For example, a garage door according to the invention may be constructed of thin-walled sheet metal or plastic having a thickness that is less than or equal to about 0.125 inch. Preferably, the material thickness is minimized to reduce cost, and to minimize the weight of the overhead doors. When the door sections are constructed of sheet metal such as aluminum or steel, the sheet metal may have a thickness of about 0.019-0.022 inch, for example.

The pattern shown in FIGS. 2-4 includes a plurality of substantially parallel spaced grooves 212 in the panel portion 200. In the embodiment shown, the grooves 212 are vertically oriented, though the grooves may be oriented in a horizontal, diagonal, or other direction if desired. The spaced grooves 212 provide the panel portion 200 with the simulated appearance of a panel constructed from a plurality of assembled, vertically arranged wooden tongue and groove planks. Such a tongue-and-groove panel construction may be found in many traditional wooden carriage house doors. As can be appreciated, the vertically oriented grooves contribute to the vertically hung appearance of the door.

As shown in FIG. 2, the panel portion 200 of embossment pattern 110 has a height “H” and a width “W.” In certain embodiments of the invention, it is desirable for the embossed patterns in the door sections to be vertically oriented. The term “vertically-oriented” as used herein with regard to the embossment patterns means that height “H” is greater than width “W.” In particular, it is desirable for the embossed patterns to have a height-to-width ratio (H/W) of at least about 1.2. This vertical orientation of the embossed patterns also contributes to the vertically hung appearance of the sectional overhead garage door.

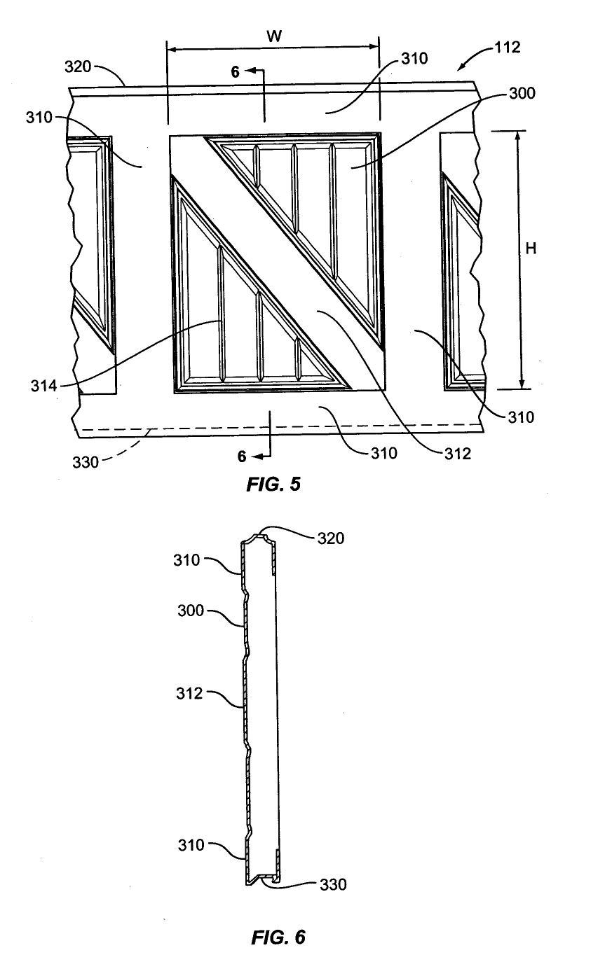

As shown in FIG. 4, the top edge of a door section may include a raised lip 220 along its length. Correspondingly, the bottom edge of the door section may include a recess 230 along its length that is substantially identical in shape to the raised lip 220 on the top edge. When a door comprising such door sections is closed, the top lip 220 on one door section is received in the recess 230 of an adjacent mating section, thereby providing a substantially water-resistant and wind-resistant seal or baffle between the mating door sections.

FIGS. 5 and 6 show another embossment pattern 112 that may be included in a garage door according to the invention. In this embodiment, the pattern 112 includes a panel portion 300 and a frame portion 310. The panel portion 300 may include a plurality of spaced parallel grooves 314 to provide the panel portion 300 with the appearance of a wooden panel constructed of vertically arranged tongue-and-groove planks. The pattern 112 also includes a downwardly sloping diagonal member 312. The term “downwardly sloping” as used herein refers to an angle that extends downwardly from left to right. The diagonal member 312 substantially simulates a “cross buck” frame member as commonly may be found in traditional carriage house doors. As described with respect to the tongue-and-groove panel design of FIGS. 2-4, the embossment pattern 112 desirably has a height-to-width ratio (H/W) greater than one, and preferably has a height-to-width ratio of at least 1.2. As shown in FIG. 6, the diagonal member 312 desirably is raised above the surface of the panel portion 300. The diagonal member 312 may be flush with the surrounding frame member portions 310, or may be slightly recessed below the frame member portions 310 as desired.

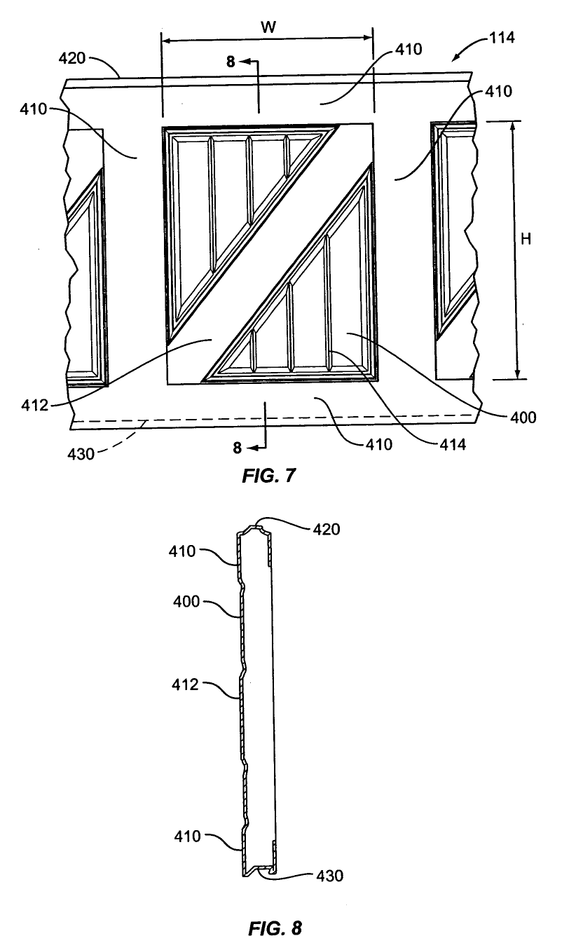

FIGS. 7 and 8 show a third embossment pattern 114 that may be used to adorn overhead garage door sections in accordance with the invention. In this embodiment, the pattern 114 includes a panel portion 400 and a frame portion 410. The panel portion 400 may include a plurality of spaced parallel grooves 414 to provide the panel portion 400 with the appearance of a wooden panel constructed of tongue-and-groove planks. The pattern 114 also includes an upwardly sloping diagonal member 412. The term “upwardly sloping” as used herein refers to an angle that extends upwardly from left to right. As described above with respect to the embossment pattern shown in FIGS. 5-6, the diagonal member 412 substantially simulates a “cross buck” frame member. The embossment pattern 114 desirably has a height-to-width ratio (H/W) greater than one, and preferably has a height-to-width ratio of at least 1.2. As shown in FIG. 8, the diagonal member 412 desirably is raised above the surface of the panel portion 400, and may be flush with or recessed below the frame member portions 410.

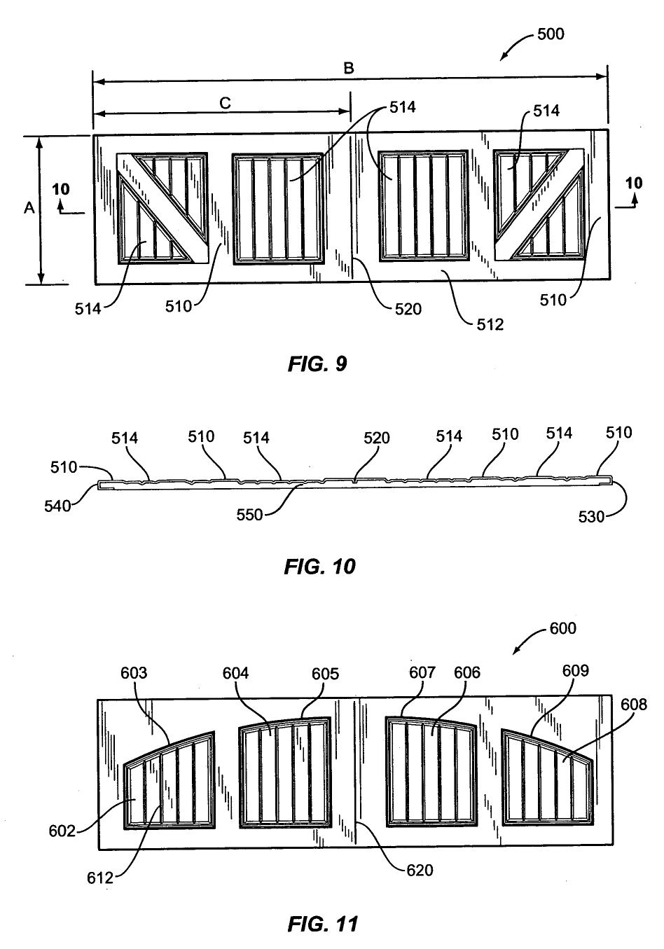

FIGS. 9 and 10 show an embodiment 500 of a garage door section for use in a garage door according to the invention. The garage door section includes a plurality of embossment patterns comprising recessed panel portions 514 embossed in the sheet metal face of the door section 500. The embossment patterns may be selected from those shown in FIGS. 2-8, or may be any other suitable pattern that contributes to the desired appearance of a complete sectional overhead garage door. The garage door section 500 includes a plurality of horizontal frame portions 512 and a plurality of vertical frame portions 510. Because a garage door in accordance with the invention is desirably either seven or eight feet in height, and because it is desirable to have a total of three pivotally connected garage door sections having substantially equal heights, the garage door section 500 desirably has a height “A” of either about twenty-eight (28) inches (for a 7-foot door), or a height of about thirty-two (32) inches (for an 8-foot door).

The garage door section 500 includes a substantially vertical groove or crease 520 that substantially extends between the upper and lower edges of the front face of the door section 500. The groove 520 has a suitable depth and width such that the groove 520 substantially provides the appearance of a complete vertical separation between left and right portions of the garage door section 500. In one embodiment, the groove is about 0.1 inches deep by about 0.2 inches wide. In order for left and right portions of the garage door section 500 to have substantially equal widths, it is desirable for the groove 520 to be substantially centered in the face of the garage door section 520. In other words, it is desirable for distance “C” in FIG. 9 to be about one-half of the door width “B”.

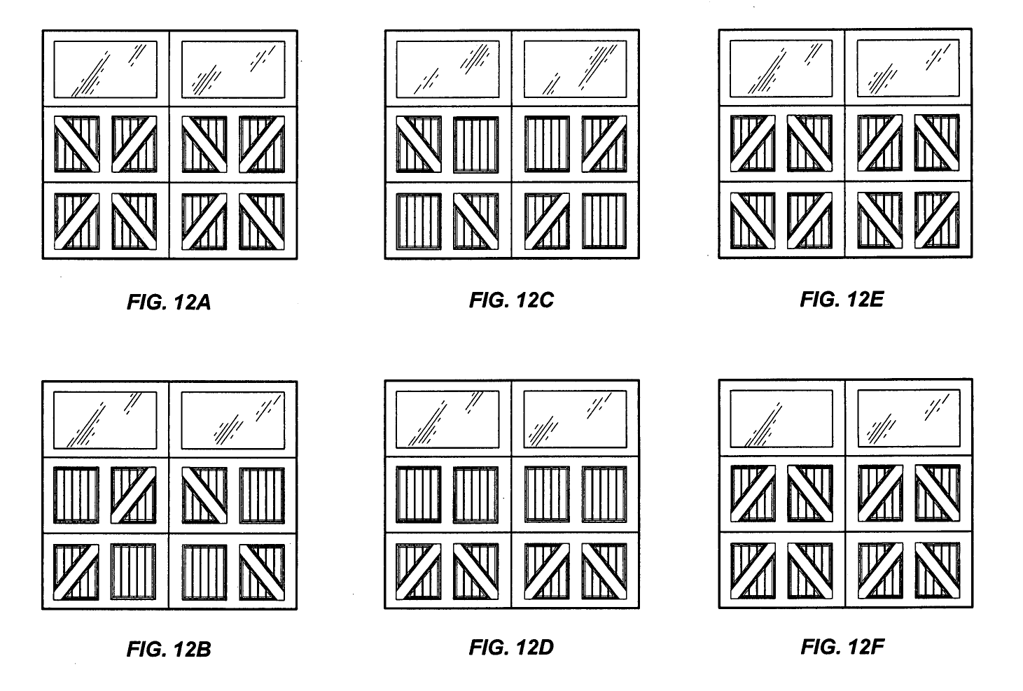

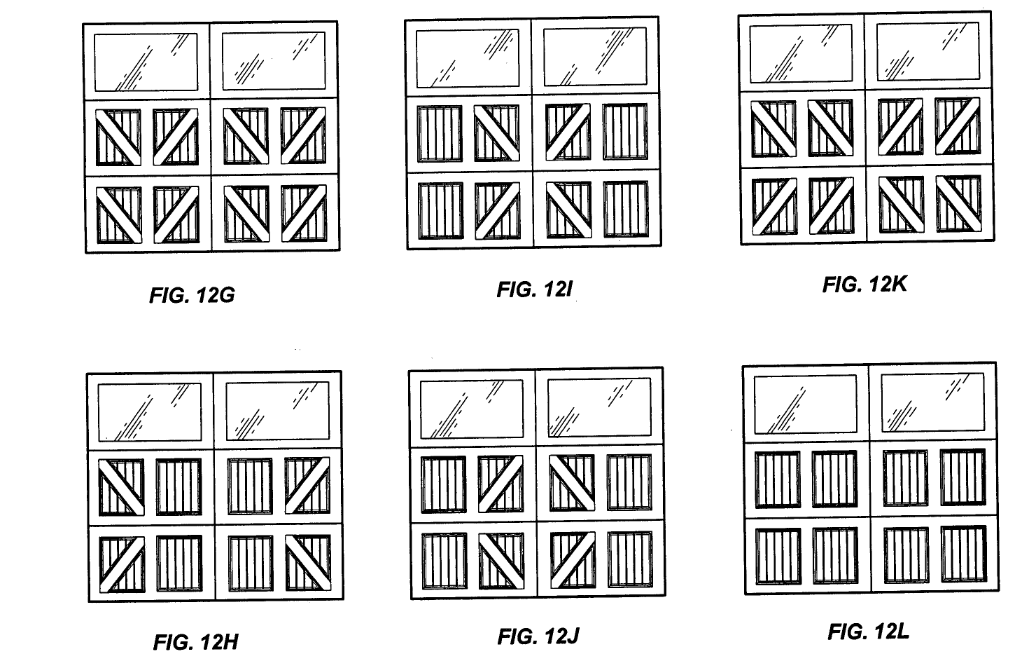

As an alternative to the glazed upper door section shown in the garage door of FIG. 1, FIG. 11 shows another embodiment 600 of an upper garage door section in accordance with the invention. In this embodiment, the upper door section includes a plurality of horizontally spaced embossed patterns 602, 604, 606, and 608. Each of the embossed patterns 602, 604, 606, and 608 includes an upper edge 603, 605, 607, and 609 that has a substantially arcuate shape. Desirably, the upper edges 603, 605, 607, and 609 are configured such that they combine to form a semi-continuous arched shape like that shown in FIG. 1. Like the door section 500 shown in FIGS. 9 and 10 and described above, the door section 600 includes a substantially vertical groove or crease 620 that is centered in the garage door section 600 and that substantially extends between upper and lower edges of the front face of the door section 600.

The garage doors and garage door sections described above preferably are substantially constructed of sheet metal such as steel or aluminum. Alternatively, the garage doors and garage door sections described above may be substantially constructed of molded plastic. Other materials or combinations of materials that provide a durable and lightweight door also may be used. Garage doors according to the invention do not utilize or rely upon overlaid elements on the faces of the door sections to impart the doors with the appearance of vertically hung doors such as carriage house doors. The door sections may include insulating layers such as a foam cores that are positioned behind the thin-walled faces of the door sections. For metal doors, the exposed surfaces of the doors desirably are coated with a protectant such as paint or another weather-resistant coating. When the door sections are steel, the sheet metal may be galvanized to enhance its corrosion resistance.

FIGS. 12A-12L show a variety of embodiments of sectional overhead garage doors constructed in accordance with the invention that substantially simulate the appearance of carriage house doors. All of the garage doors shown in FIGS. 12A-12L include three garage door sections, at least two of which are embossed with a series of embossment patterns comprising one of the three embossment patterns shown in FIGS. 2-4 (tongue-and-groove panel), FIGS. 5 and 6 (downward-sloping diagonal frame member), and FIGS. 7 and 8 (upward-sloping diagonal frame member). Therefore, substantial portions of these garage doors can be produced by combining garage door sections that include various combinations of these three different embossment patterns. The various garage door configurations shown in FIG. 12 illustrate a portion of the wide variety of garage doors that can be produced according to the invention. It should be understood, however, that many garage door designs other than those specifically shown can be produced according to the invention, and that the invention is not limited to the illustrated embodiments.

The invention also includes an economical method for producing a wide variety of sectional overhead garage doors that substantially simulate the appearance of vertically hung doors such as carriage house doors. One embodiment of the method includes providing a set of dies comprising three different die configurations. A first die may be configured to emboss a relief pattern in a sheet metal garage door section like that shown in FIGS. 2-4 (tongue-and-groove panel), for example. A second die may be configured to emboss a relief pattern like that shown in FIGS. 5 and 6 (downward-sloping diagonal frame member). A third die may be configured to emboss a relief pattern like that shown in FIGS. 7 and 8 (upward-sloping diagonal frame member). This embodiment of the method further includes producing a plurality of embossed metal garage door sections with the set of dies such that each section includes at least one embossed pattern. In other words, a particular door section may be embossed with one of a series of identical embossment patterns, or a door section may be embossed with any combination of two to three different embossment patterns.

Once the garage door sections are so produced with a desired combination of embossment patterns, the door sections are selectively arranged and pivotally connected to each other to form at least a substantial portion of an overhead garage door that has a desired appearance when the garage door is closed. For example, two garage door sections produced according to this embodiment of the method may combined with a glazed upper door section to form a garage door like that shown in FIG. 1. Alternatively, two garage door sections produced according to this embodiment of the method may be combined with an upper door section like that shown in FIG. 11 to form a metal garage door that has the substantial appearance of a carriage house door. Still further, three or more garage door sections produced according to this method may be combined to form a complete garage door. Though this embodiment of the described method is described with reference to the specific embodiments of embossment patterns described above, it should be understood that the method could be practiced using other embossment patterns not specifically described herein without departing from the invention.

Although specific embodiments of the present invention have been described in detail, persons of ordinary skill in the art will understand that the invention is not limited thereto. The above detailed description of embodiments of the invention is provided for example only and should not be construed as limiting the invention. Modifications and substitutions will be apparent to those skilled in the art, and all modifications and substitutions that do not depart from the spirit of the invention are intended to be included within the scope of the appended claims.

1. An overhead garage door comprising a plurality of rectangular garage door sections, the sections being pivotally connected together one above the other, each door section including at least one thin-walled face panel and one or more patterns embossed in the face panel, wherein the embossed patterns in the face panels provide the garage door with the simulated appearance of at least two separate, cooperating vertically-hung doors when the garage door is in a closed position.

2. An overhead garage door according to claim 1 wherein the embossed patterns provide the garage door with the simulated appearance of at least two cooperating vertically-hung doors that are substantially constructed of a plurality of spaced interconnected vertical and horizontal frame members and a plurality of substantially planar inset panels disposed between the spaced frame members.

3. An overhead garage door according to claim 2 wherein the embossed patterns provide at least a portion of the face panels of the garage door with the simulated appearance of inset panels formed by a plurality of interconnected tongue-and-groove planks.

4. An overhead garage door according to claim 2 wherein the embossed patterns further provide the garage door with the simulated appearance of at least two cooperating vertically hung doors that include at least one diagonal frame member.

5. An overhead garage door according to claim 1 wherein the thin-walled face panels are substantially constructed of sheet metal.

6. An overhead garage door according to claim 1 wherein the thin-walled face panels are substantially constructed of plastic.

7. An overhead garage door according to claim 1 wherein each garage door section further comprises at least one layer of insulation therein.

8. An overhead garage door comprising:
(a) a substantially rectangular upper section, the upper section including an thin-walled upper face panel having an upper front face, an upper edge, a lower edge, and side edges, the upper front face comprising a first integrally-formed substantially vertical groove substantially extending between the upper and lower edges;
(b) a substantially rectangular lower section, the lower section including a thin-walled lower face panel having a lower front face, a top edge, a lower edge, and side edges, the lower front face comprising a second integrally-formed substantially vertical groove substantially extending between the top and bottom edges;
(c) at least one connector pivotally connecting the bottom edge of the upper section to the top edge of the lower section, the upper and lower front faces being substantially coplanar when the garage door is in a closed position;
(d) wherein the first and second substantially vertical grooves are substantially collinear when the garage door is in the closed position, thereby substantially simulating the appearance of a vertical separation between left and right portions of the upper and lower sections.

9. An overhead garage door according to claim 8 wherein at least one of the upper and lower front faces includes one or more embossed patterns that provide the simulated appearance of an inset panel portion.

10. An overhead garage door according to claim 9 wherein each embossed pattern is substantially rectangular and has a height to width ratio of at least about 1.2.

11. An overhead garage door according to claim 9 wherein each embossed pattern comprises a substantially planar portion including a plurality of spaced, vertical, substantially parallel grooves, the substantially planar portion thereby substantially simulating the appearance of an inset panel formed by a plurality of assembled tongue-and-groove planks.

12. An overhead garage door according to claim 11, wherein each embossed pattern further comprises an integrally-formed, diagonally-oriented, simulated support member.

13. An overhead garage door according to claim 9, wherein each embossed pattern further comprises an integrally-formed, diagonally-oriented, simulated support member.

14. An overhead garage door according to claim 8 wherein the substantially vertical first and second grooves in the upper and lower sections are substantially horizontally centered between the side edges of the upper and lower sections.

15. An overhead garage door according to claim 8, the garage door further comprising:
(a) a first embossed pattern integrally formed in the upper front face of the upper section, the first embossed pattern comprising an integrally-formed panel portion, and a first raised, integrally-formed, diagonally-oriented, simulated support member having a first longitudinal axis that is nonparallel to any edge of the upper section; and
(b) a second embossed pattern integrally-formed in the lower front face of the lower section, the second embossed pattern comprising an integrally formed panel portion, and a raised, integrally-formed, diagonally-oriented, simulated support member having a second central longitudinal axis that is nonparallel to any of the edges of the lower section;
(c) wherein the upper and lower sections are substantially coplanar and the first and second central longitudinal axes of the simulated support members are substantially collinear when the garage door is in a closed position.

16. An overhead garage door according to claim 8 wherein at least one of the panel portions in the upper or lower sections is substantially rectangular and has a height to width ratio of at least about 1.2:1.

17. An overhead garage door according to claim 8 wherein the upper section includes an embossed pattern having a substantially arcuate upper edge.

18. An overhead garage door according to claim 8 wherein the upper section includes at least one window opening.

19. An overhead garage door according to claim 8 wherein the upper and lower sections are substantially constructed of sheet metal.

20. An overhead garage door according to claim 8 wherein the upper and lower sections are substantially constructed of plastic.

21. An overhead garage door according to claim 8 wherein the upper section includes at least one upper insulation layer therein, and wherein the lower panel includes at least one lower insulation layer therein.

22. An overhead garage door comprising an embossed pattern in a thin-walled face panel, the embossed pattern comprising an integrally-formed panel portion, the panel portion having a substantially planar portion including a plurality of spaced, vertically, parallel grooves, the substantially planar portion thereby substantially simulating the appearance of a non-metal panel formed by a plurality of assembled tongue-and-groove planks.

23. An overhead garage door according to claim 22, wherein the embossed pattern further comprises a substantially rectangular raised frame portion surrounding the panel portion.

24. An overhead garage door according to claim 22, wherein the panel portion is substantially rectangular in shape and includes a height and a width, wherein the ratio of the height to the width is at least about 1.2:1.

25. An overhead garage door according to claim 22 wherein the thin-walled face panel is substantially constructed of sheet metal.

26. An overhead garage door according to claim 22 wherein the thin-walled face panel is substantially constructed of plastic.

27. An overhead garage door having an integrally embossed pattern in a thin-walled face, the embossed pattern comprising:
(a) an integrally-formed panel portion having a rectangular frame portion bordering top, bottom, and side margins of the raised panel;
b) a recessed, substantially planar panel portion disposed within the rectangular frame portion; and
(c) at least one integrally-formed, diagonally-oriented, simulated support member disposed within the frame portion of the panel.

28. An overhead garage door having an embossed pattern according to claim 27, wherein the panel portion has a height and a width, and wherein the ratio of the height to the width is at least about 1.2:1.

29. An overhead garage door having an embossed pattern according to claim 27, wherein the substantially planar panel portion includes a plurality of spaced, vertically-oriented, parallel grooves, the substantially planar portion thereby substantially simulating the appearance of a non-metal panel formed by a plurality of assembled tongue-and-groove planks.

30. A method of constructing an overhead garage door, the method comprising:
(a) providing a set of dies for forming a plurality of embossed patterns in a sheet metal garage door section, the set of dies comprising:
(i) a first die configured for forming a first embossed pattern comprising an integrally-formed, diagonally-oriented, upwardly-sloping simulated support member;
(ii) a second die configured for forming a second embossed pattern comprising a raised, integrally-formed, diagonally-oriented, downwardly-sloping simulated support member; and
(iii) a third die configured for forming a third embossed pattern that is substantially different from the first and second embossed patterns;
(b) producing a plurality of embossed metal garage door sections with the set of dies such that each section includes at least one selected embossed pattern;
(c) selectively arranging and pivotally connecting the plurality of garage door sections together to form at least a substantial portion of an overhead garage door having a desired appearance in a closed position.

31. A method of constructing an overhead garage door according to claim 30, wherein at least one of the selected embossed patterns for at least one of the door sections is the first or second embossed pattern.

32. A method of constructing an overhead garage door according to claim 30 wherein at least one of the first, second, and third dies is further configured for forming an embossed pattern that includes a substantially planar panel portion having a plurality of spaced, vertically-oriented, parallel grooves, the substantially planar portion thereby substantially simulating the appearance of a non-metal panel formed by a plurality of assembled tongue-and-groove planks.

33. A method of constructing an overhead garage door according to claim 30 wherein the first, second, and third embossed patterns have substantially rectangular shapes, each substantially rectangular shape having a height and width wherein the ratio of the height to the width is at least about 1.2:1.
